(19) United States
(12) Patent Application Publication
(10) Pub. No.: US 2015/0196933 A1
(43) Pub. Date: Jul. 16, 2015

(54) CARBON DIOXIDE AND CARBON MONOXIDE MEDIATED CURING OF LOW K FILMS TO INCREASE HARDNESS AND MODULUS

(71) Applicant: Applied Materials, Inc., Santa Clara, CA (US)

(72) Inventors: Pramit MANNA, Santa Clara, CA (US); Kiran V. THADANI, Sunnyvale, CA (US); Abhijit Basu MALLICK, Fremont, CA (US)

(21) Appl. No.: 14/574,101

(22) Filed: Dec. 17, 2014

Related U.S. Application Data
(60) Provisional application No. 61/926,809, filed on Jan. 13, 2014.

(51) Int. Cl. B05D 3/06; B05D 3/02; B05D 3/04

(52) U.S. Cl. CPC B05D 3/068; B05D 3/066; B05D 3/067; B05D 3/04; B05D 3/0254

(57) ABSTRACT

Embodiments of the invention generally relate to methods of curing a carbon/silicon-containing low k material. The methods generally include delivering a deposition precursor to the processing region, the deposition precursor comprising a carbon/silicon-containing precursor, forming a remote plasma in the presence of an oxygen containing precursor, delivering the activated oxygen containing precursor to the deposition precursor to deposit a carbon/silicon-containing low k material on the substrate and curing the carbon/silicon-containing low k material in the presence of a carbon oxide gas.

### CROSS-REFERENCE TO RELATED APPLICATIONS

This application claims benefit of U.S. Provisional Patent Application Ser. No. 61/926,809, filed Jan. 13, 2014, which is herein incorporated by reference.

### BACKGROUND

1. Field

Embodiments described herein generally relate to methods of maintaining or improving the mechanical properties of a low k material. More specifically, embodiments disclosed herein generally relate to methods of increasing the hardness and modulus of a film.

2. Description of the Related Art

Semiconductor device geometries have dramatically decreased in size since such devices were first introduced several decades ago. Since then, integrated circuits have generally followed the two year/half-size rule (often called Moore's Law), which means that the number of devices that will fit on a chip doubles every two years. Today's fabrication plants are routinely producing devices having 0.35 μm and even 0.25 μm feature sizes, and tomorrow's plants soon will be producing devices having even smaller geometries.

In order to further reduce the size of devices on integrated circuits, it has become beneficial to use conductive materials having low resistivity and insulators having low k (dielectric constant <3) to reduce the capacitive coupling between adjacent metal lines. Unfortunately, low k materials (typically dielectrics whose dielectric constant is below that of silicon oxide) exhibit fundamentally weaker electrical and mechanical properties (such as hardness and Young's modulus) as compared to silicon oxide. Further, the low k dielectric alternatives are typically susceptible to damage during the various interconnect processing steps. The damage observed in the low k materials is manifested by an increase in the dielectric constant and increased moisture uptake, which may result in reduced performance and device reliability.

Due to the damage observed above, curing of low k materials is critical to achieve desired thermal properties, modulus, and hardness without sacrificing the dielectric constant. In general, low k materials contain significant amount of free carbon in the film which can be removed in a controlled way during the cure. Delivering O₂ during the curing process often helps to reduce cure time and improve elasticity and hardness values. However, when O₂ is used in a UV cure, O₃ can be produced in situ. O₃ can potentially form Si—OH bonds with the flowable low k films and reduce the k value.

Therefore, there is a need for improved methods of maintaining both the low k value and the mechanical properties of low k films.

### SUMMARY OF THE INVENTION

Embodiments of the invention generally relate to methods of curing a low k material. In one embodiment, a method of curing a film can include delivering a carbon oxide gas to a substrate in a processing region of a processing chamber, the substrate having a carbon/silicon-containing low k material deposited thereon; controlling the temperature of the substrate such that the substrate is between 200 degrees Celsius and 550 degrees Celsius; and delivering UV radiation to the processing chamber to create a cured carbon/silicon-containing low k film.

In another embodiment, a method of forming a low k film can include positioning a substrate in a processing region of a processing chamber; delivering a deposition precursor to the processing region, the deposition precursor comprising a carbon/silicon-containing precursor; forming a remote plasma in the presence of an oxygen containing precursor to create an activated oxygen containing precursor; delivering the activated oxygen containing precursor to the deposition precursor in the presence of the substrate to deposit a carbon/silicon-containing low k material on the substrate; and curing the carbon/silicon-containing low k material in the presence of a carbon oxide gas.

In another embodiment, a method of forming a low k film can include positioning a substrate in a processing region of a processing chamber; delivering a deposition precursor to the processing region, the deposition precursor comprising octamethylcyclotetrasiloxane (OMCTS); forming a remote plasma in the presence of oxygen (O₂) to create an activated oxygen; delivering the activated oxygen to the deposition precursor in the presence of the substrate to deposit a carbon/silicon-containing low k film on the substrate; delivering a curing gas comprising carbon dioxide or carbon monoxide to the processing chamber; controlling the temperature of the substrate such that the substrate is between 200 degrees Celsius and 550 degrees Celsius; and delivering UV radiation to the substrate and the curing gas to create a cured carbon/silicon-containing low k film.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts a system including deposition and curing chambers, according to one or more embodiments;

FIG. 2 is a block diagram of a method for depositing a low k material, according to one or more embodiments; and

FIG. 3 is a block diagram of a method for curing a low k material, according to one or more embodiments.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments of the invention generally relate to methods of improving hardness and Young's modulus in low k dielectric films, such as carbon doped silicon oxide (SiOC) films. A low k dielectric film is deposited on an exposed surface of a substrate. In one embodiment, the low k dielectric film is a carbon/silicon-containing low k dielectric film, such as a silicon oxygen carbon containing (SiOC) film. The film can be deposited using a two step remote plasma deposition, described in more detail below. The low k dielectric film can then be cured using a carbon monoxide/carbon dioxide mediated cure to overcome the above challenges. Embodiments disclosed herein are described in greater detail with reference to the figures below.

Processing chambers that may be used or modified for use with embodiments of the present invention may include high-density plasma chemical vapor deposition (HDP-CVD) chambers, plasma enhanced chemical vapor deposition (PECVD) chambers, sub-atmospheric chemical vapor deposition (SACVD) chambers, and thermal chemical vapor processing chambers, among other types of chambers. Specific examples of CVD systems that may implement embodiments of the invention include the CENTURA ULTIMA® HDP-CVD chambers/systems, and PRODUCER® PECVD chambers/systems, available from Applied Materials, Inc. of Santa Clara, Calif. Embodiments of the deposition systems may be incorporated into larger fabrication systems for producing integrated circuit chips.

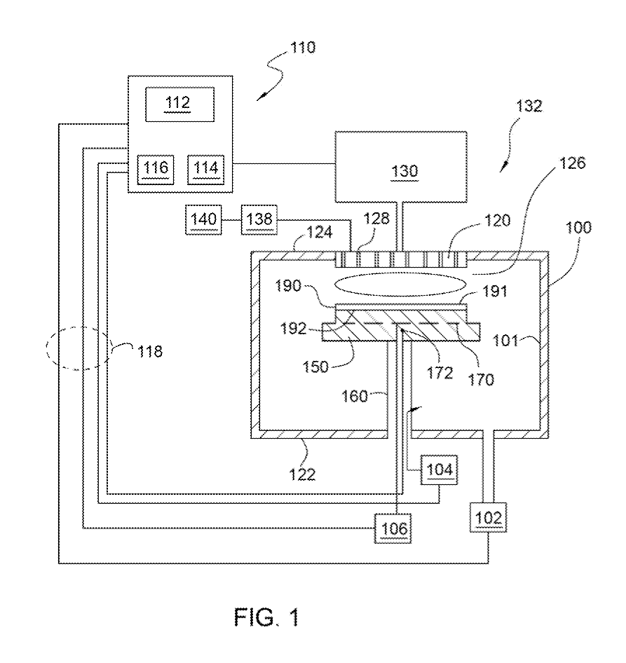

FIG. 1 depicts a schematic illustration of a processing system 132 that can be used to deposit a flowable silicon-carbon-nitrogen layer in accordance with embodiments described herein.

The processing system 132 includes a processing chamber 100 coupled to a gas panel 130 and a controller 110. The processing chamber 100 generally includes a top 124, a side 101 and a bottom wall 122 that define an interior processing region 126. A support pedestal 150 is provided in the interior processing region 126 of the chamber 100. The pedestal 150 is supported by a stem 160 and may be typically fabricated from aluminum, ceramic, and other suitable materials. The pedestal 150 may be moved in a vertical direction inside the chamber 100 using a displacement mechanism (not shown).

The pedestal 150 may include an embedded heater element 170 suitable for controlling the temperature of a substrate 190 supported on a surface 192 of the pedestal 150. The pedestal 150 may be resistively heated by applying an electric current from a power supply 106 to the heater element 170. The heater element 170 may be made of a nickel-chromium wire encapsulated in a nickel-iron-chromium alloy (e.g., INCOLOY®) sheath tube. The electric current supplied from the power supply 106 is regulated by the controller 110 to control the heat generated by the heater element 170, thereby maintaining the substrate 190 and the pedestal 150 at a substantially constant temperature during film deposition. The supplied electric current may be adjusted to selectively control the temperature of the pedestal 150 between about 100 degrees Celsius to about 700 degrees Celsius, such as from about 200 degrees Celsius to about 500 degrees Celsius. The pedestal 150 may also include a chiller (not shown) suitable for lowering the temperature of a substrate 190 supported on a surface 192 of the pedestal 150. The chiller may be adjusted to selectively lower the temperature of the pedestal 150 to temperatures of about −10 degrees Celsius or lower.

A temperature sensor 172, such as a thermocouple, may be embedded in the support pedestal 150 to monitor the temperature of the pedestal 150 in a conventional manner. The measured temperature is used by the controller 110 to control the power supplied to the heater element 170 to maintain the substrate at a desired temperature.

A vacuum pump 102 is coupled to a port formed in the bottom of the chamber 100. The vacuum pump 102 is used to maintain a desired gas pressure in the processing chamber 100. The vacuum pump 102 also evacuates post-processing gases and by-products of the process from the chamber 100.

The processing system 132 may further include additional equipment for controlling the chamber pressure, for example, valves (e.g. throttle valves and isolation valves) positioned between the processing chamber 100 and the vacuum pump 102 to control the chamber pressure.

A showerhead 120 having a plurality of apertures 128 is disposed on the top of the processing chamber 100 above the substrate support pedestal 150. The apertures 128 of the showerhead 120 are utilized to introduce process gases into the chamber 100. The apertures 128 may have different sizes, number, distributions, shape, design, and diameters to facilitate the flow of the various process gases for different process requirements. The showerhead 120 is connected to the gas panel 130 that allows various gases to supply to the interior processing region 126 during process.

In the embodiment shown, showerhead 120 can distribute process gases which contain oxygen, hydrogen, silicon, carbon and/or nitrogen. In embodiments, the process gas introduced into the processing region 126 can contain one or more of oxygen (O₂), ozone (O₃), N₂O, NO, NO₂, NH₃, NₓH_{y} including N₂H₄, silane, disilane, TSA, DSA, alkyl amines, organosilicon compounds, hydrocarbon compounds and combinations thereof. The process gas may also include a carrier gas such as helium, argon, nitrogen (N₂), etc. The second channel (not shown) may also deliver a process gas and/or a carrier gas, and/or a film-curing gas (e.g. CO₂) used to cure or mechanically strengthen the growing or as-deposited film. Plasma effluents may include ionized or neutral derivatives of the process gas and may also be referred to herein as an activated carbon oxide precursor.

The processing chamber 100 can further include a remote plasma source 138. The remote plasma source 138 produce a plasma from one or more gases, such as a gas delivered from a secondary gas source 140. The remote plasma source 138 can produce a plasma as known in the art from available plasma power sources, such as an inductively coupled plasma (ICP), a microwave plasma (MWP) or a capacitively coupled plasma (CCP).

The controller 110 includes a central processing unit (CPU) 112, a memory 116, and a support circuit 114 utilized to control the process sequence and regulate the gas flows from the gas panel 130. The CPU 112 may be of any form of a general purpose computer processor that may be used in an industrial setting. The software routines can be stored in the memory 116, such as random access memory, read only memory, floppy, or hard disk drive, or other form of digital storage. The support circuit 114 is conventionally coupled to the CPU 112 and may include cache, clock circuits, input/output systems, power supplies, and the like. Bi-directional communications between the controller 110 and the various components of the processing system 132 are handled through numerous signal cables collectively referred to as signal buses 118, some of which are illustrated in FIG. 1.

Other processing chambers may also benefit from the present invention and the parameters listed above may vary according to the particular processing chamber used to form and cure the low k dielectric layer. For example, other processing chambers may have a larger or smaller volume, requiring gas flow rates that are larger or smaller than those recited for processing chambers available from Applied Materials, Inc.

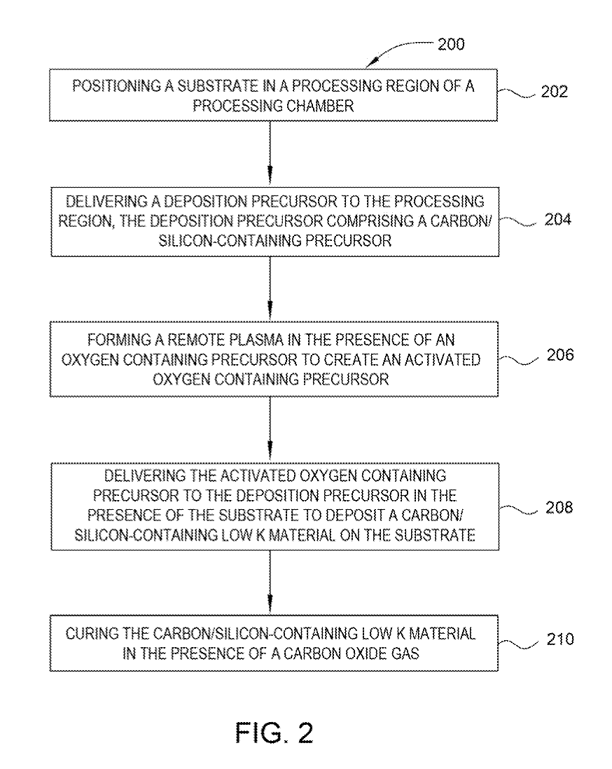

FIG. 2 is a block diagram of a method 200 for depositing a low k dielectric material, according to one or more embodiments. The method 200 begins by positioning a substrate in a processing chamber, as in element 202. In one embodiment, the processing chamber is a chamber as described with reference to FIG. 1. In another embodiment, the processing chamber is any chamber which is capable of producing a remote plasma to be delivered to the processing region of the processing chamber, including chambers modified to produce the same. The substrate can be any substrate used in the deposition of thin films, such as a silicon substrate.

Once the substrate is positioned in the processing chamber, a deposition precursor can be delivered to the processing region, as in element 204. The deposition precursor comprises a carbon/silicon-containing precursor. The carbon/silicon-containing precursor can be an organosilicon compound, a hydrocarbon compound or combinations thereof.

In one embodiment, the organosilicon compound may have a ring structure, linear structure, or fullerene structure. Examples of organosilicon compounds that may be used that have ring structures include octamethylcyclotetrasiloxane (OMCTS); 1,3,5,7-tetramethylcyclotetrasiloxane (TMCTS); 1,2,3,4-tetramethylcyclotetrasilane; hexamethylcyclotrisiloxane; hexaethylcyclotrisiloxane; hexaphenylcyclotrisiloxane; 1,3,7-tetravinyl-1,3,5,7-tetramethylcyclotetrasiloxane; 1,3,5,7,9-pentamethylcyclopentasiloxane; and 1,3,5,7,9-pentavinyl-1,3,5,7,9-pentamethylcyclopentasiloxane. Examples of organosilicon compounds that may be used that have linear structures include trimethylsilane; tetramethylsilane; 1,1,3,3-tetramethyldisiloxane; tetravinylsilane; diphenylmethylsilane; tetraphenylsilane; tetra-n-propoxysilane; diethoxymethylsilane; 1,1,3,3-tetramethyl-1,3-diethoxydisiloxane; tetramethoxysilane (TMOS); and 1,1,3,3-tetramethyldisilazane. Examples of organosilicon compounds that may be used that have fullerene structures, e.g., spherical or cuboidal structures, include silsequioxane structures, such as hydro-T8-silsesquioxane, octamethyl-T8-silsequioxane, octavinyl-T8-silsesquioxane, and octakis(dimethylsiloxy)-T8-silsesquioxane. If an organosilicon compound having a ring structure or fullerene structure is used, the organosilicon compound can be dissolved in a solvent such as hexane before introducing the compound into the processing chamber.

The carbon/silicon-containing compounds can also include a hydrocarbon. The hydrocarbon may have a ring structure, linear structure, or fullerene structure. Examples of types of hydrocarbons that may be used that have ring structures include cyclic terpenes, cyclopentenes, cyclohexenes, cyclohexanes, cyclohexadienes, cycloheptadienes, and phenyl-containing compounds. For example, alpha terpinene (C₁₀H₁₆) (ATP), 1-methyl-4-(1-methylethenyl)-cyclohexene, 1-methyl-4-isopropylcyclohexane, p-isopropyl-toluene, vinylcyclohexane, norbornadiene, phenyl acetate, cyclopentene oxide, and combinations thereof may be used. Examples of hydrocarbons that may be used that have linear structures include ethylene, hexane, propylene, and 1,3-butadiene. Examples of hydrocarbons that may be used that have fullerene structures include C₆₀, C₇₀, C₇₆, and C₇₈. If a hydrocarbon having a ring structure or a fullerene structure is used, the hydrocarbon can be dissolved in a solvent such as hexane and tetrahydrofuran before introducing the compound into the processing chamber.

Two or more compounds, such as two or more organosilicon compounds, may simultaneously delivered to the deposition chamber. The organosilicon flow rates may be about 50 sccm to about 5000 sccm. Oxidizing gas flow rates may be from 50 sccm to about 3000 sccm, and hydrocarbon flow rates may from 50 sccm to about 5000 sccm. The pressure can be maintained between 0.5 Torr and 3 Torr and at a temperature between 50 degrees Celsius and 100 degrees Celsius. The effective deposition rate can be between 2000 Å/min and 10000 Å/min.

When the carbon/silicon-containing layer is deposited using OMCTS, a silane precursor is also used. An exemplary silane precursor is TMOS. The OMCTS and the silane precursor are combined at an OMCTS to silane precursor ratio of between 1:2.5 to 10:1. In one embodiment, the carbon/silicon-containing precursor comprises TMOS, OMCTS and a carrier gas. TMOS can be delivered at a flow rate of 100 sccm to 3000 sccm. OMCTS can be delivered at a flow rate of 500 sccm to 3000 sccm. The carrier gas can be an inert gas, such as helium. In this embodiment, helium is delivered at a flow rate of 1000 sccm to 10000 sccm. All flow rates are described with reference to a 300 mm substrate. Thus in this embodiment, TMOS is delivered at a flow rate of from 0.0011 sccm/mm² to 0.033 sccm/mm² of substrate surface area, OMCTS is delivered at a flow rate of from 0.0056 sccm/mm² to 0.033 sccm/mm² of substrate surface area and helium is delivered at a flow rate of from 0.011 sccm/mm² to 0.11 sccm/mm² of substrate surface area.

Oxygen is present in the carbon/silicon-containing low k dielectric layer, which can be a carbon-doped silicon oxide layer. In one embodiment, the carbon/silicon-containing low k dielectric layer is a carbon-doped silicon oxide film that includes about 10% to about 60% silicon, about 20% to about 30% oxygen, and about 10% to about 60% carbon. In another embodiment, the carbon/silicon-containing low k dielectric layer is a porous carbon-doped silicon oxide film that has a k<3.0. However, it is recognized that other types of low k dielectric films can be deposited using the methods described herein. Further, it is understood that the methods described herein may be applied to other low k dielectric films.

Then, a remote plasma can be formed in the presence of an oxygen-containing precursor to create an activated oxygen-containing precursor, as in element 206. The oxygen-containing precursor can be a substance which includes one or more oxygen atoms, such as a gas which is at least 50 atomic percent oxygen. In one embodiment, the oxygen-containing precursor gas is selected from oxygen (O₂), ozone (O₃), CO, CO₂, N₂O, NO, NO₂ or combinations thereof.

When O₂ is used as the oxygen containing gas, the O₂ is delivered to the remote plasma source. At the remote plasma source, the O₂ is either converted to a plasma or added to a preexisting plasma, such as a plasma created from an inert gas, which converts the O₂ to an activated O₂ gas. The oxygen containing gas can be delivered at a flow rate of 1000 sccm to 5000 sccm. All flow rates are described with reference to a 300 mm substrate. Thus in this embodiment, the oxygen containing gas is delivered at a flow rate of from 0.011 sccm/mm² to 0.056 sccm/mm² of substrate surface area.

The activated oxygen containing precursor can then be delivered to the deposition precursor in the presence of the substrate, as in element 208. In one embodiment, the activated O₂ produced by the remote plasma source can be delivered to the processing region of the processing chamber in either a plasma form or as an activated gas after the plasma is quenched. The activated O₂ then mixes with the carbon/silicon-containing precursor (described above) in the processing region of the processing chamber. The activated O₂ interacts with the carbon/silicon-containing precursor to provide the energy for deposition of a carbon/silicon-containing low k material onto the substrate.

Once the carbon/silicon-containing low k material is deposited, it can then be cured in the presence of a carbon oxide gas, as in element 210. A carbon oxide gas is a gas which is essentially composed of carbon and oxygen. Exemplary gases include carbon dioxide and carbon monoxide. The UV cure is more clearly described below. However, the cure can be performed using ultraviolet (UV) radiation, microwave (MW) radiation or e-beam cures.

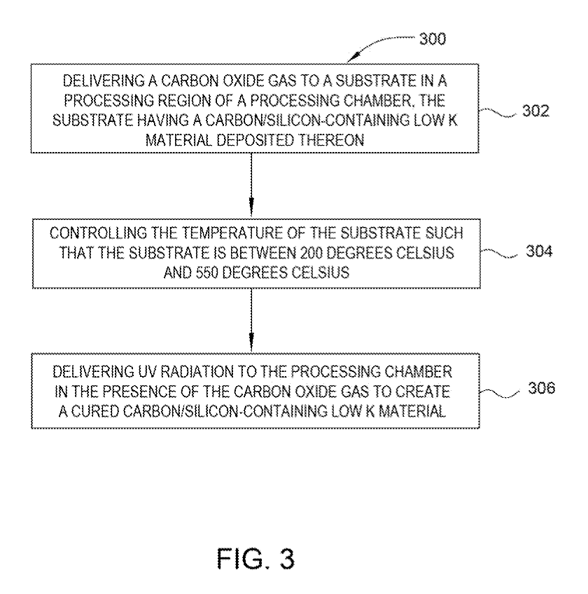

FIG. 3 is a block diagram of a method 300 for depositing a low k dielectric material, according to one or more embodiments. The method 300 begins with delivering a carbon oxide gas to a substrate in a processing region of a processing chamber, as in element 302. As described here, the substrate has a carbon/silicon-containing low k material deposited on at least one exposed surface. In one embodiment, the carbon/silicon-containing low k material is a SiOC material. In another embodiment, the carbon/silicon-containing low k material is a carbon/silicon-containing material with a k value of less than 3.

The carbon oxide gas can be delivered using similar parameters to the deposition gas described with reference to FIG. 2. The carbon oxide gas can be delivered at a flow rate of 100 sccm to 5000 sccm. All flow rates are described with reference to a 300 mm substrate. Thus in this embodiment, the carbon oxide gas is delivered at a flow rate of from 0.0011 sccm/mm² to 0.056 sccm/mm² of substrate surface area. The pressure during the cure can be maintained between 100 mTorr and 3 Torr. Further, the carbon oxide gas can be delivered with one or more secondary gases, such as an inert gas.

Next, the temperature of the substrate can be controlled such that the substrate is between 200 degrees Celsius and 550 degrees Celsius, as in element 304. Higher temperatures are believed to decrease the cure time. However, many formations on the substrate may be sensitive to high temperatures, which could damage the device. The exact temperature which is appropriate will be specific to the film and devices produced on the substrate.

Next, UV radiation can be delivered to the processing chamber in the presence of the carbon oxide gas to create a cured carbon/silicon-containing low k material, as in element 306. One or more carbon oxide gases may be delivered to the chamber simultaneously with the delivery of UV radiation. The UV radiation can further be delivered to the chamber generally or specifically to the substrate to ionize the carbon oxide gas. The ionized carbon and oxygen molecules will act to remove moisture and loosely bound carbon, without forming deleterious compounds on the surface of the carbon/silicon-containing low k material.

It is believed that carbon oxides can provide the benefits of an oxygen cure without detrimental hydroxide formation. Oxidizers are generally present to assist the cure process by helping to reduce and cure time and improve modulus and hardness. However, having an oxidizer such as O₂ present during the curing process, such as a UV curing process, can produce O₃ in situ. O₃ can potentially form Si—OH bonds with carbon/silicon-containing low K films. The reaction with O₃ can thus contribute to a reduction in film hardness and modulus. By using of CO₂ and CO during the cure, faster and efficient curing can be achieved. CO₂ upon exposure to UV/MW/E-beam can enhance the cross-linking of the carbon/silicon-containing low k material without forming undesired Si—OH bonds, leading to better mechanical properties while maintaining a low k value.

Methods described herein can describe the deposition and cure of a low k film using carbon oxides. By deposition a carbon/silicon-containing low k material followed by subsequent cure using a carbon oxide, excess carbon is removed from the film providing a low k film without the mechanical defects found when using O₂ alone. Thus, curing with carbon oxides can provide the benefits of using oxygen during a cure without the deleterious effects.

While the foregoing is directed to embodiments of the present invention, other and further embodiments of the invention may be devised without departing from the basic scope thereof, and the scope thereof is determined by the claims that follow.

We claim:

1. A method of curing a film, comprising:
delivering a carbon oxide gas to a substrate in a processing region of a processing chamber, the substrate having a carbon/silicon-containing low k material deposited thereon;
controlling the temperature of the substrate such that the substrate is between 200 degrees Celsius and 550 degrees Celsius; and
delivering UV radiation to the processing chamber to create a cured carbon/silicon-containing low k film.

2. The method of claim 1, wherein the carbon/silicon-containing low k material is between 20 Å and 50 Å thick.

3. The method of claim 1, wherein the carbon oxide gas comprises carbon dioxide, carbon monoxide. or combinations thereof.

4. The method of claim 1, wherein the UV radiation is delivered to the substrate at a power level between 30% and 90% of the maximum power

5. The method of claim 1, wherein the flowable silicon-carbon-nitrogen material is cured by a UV cure performed at a temperature between 300 degrees Celsius and 500 degrees Celsius using a UV radiation power of between 30% and 90% of maximum power.

6. The method of claim 1, wherein the carbon/silicon-containing low k material is an SiOC material.

7. The method of claim 1, wherein the carbon oxide gas is delivered at a flow rate of between 0.0011 sccm/mm² and 0.033 sccm/mm².

8. The method of claim 1, wherein the UV radiation is delivered to the substrate.

9. A method of forming a low k film, comprising:
positioning a substrate in a processing region of a processing chamber;
delivering a deposition precursor to the processing region, the deposition precursor comprising a carbon/silicon-containing precursor;
forming a remote plasma in the presence of an oxygen containing precursor to create an activated oxygen containing precursor;
delivering the activated oxygen containing precursor to the deposition precursor in the presence of the substrate to deposit a carbon/silicon-containing low k material on the substrate; and
curing the carbon/silicon-containing low k material in the presence of a carbon oxide gas.

10. The method of claim 9, wherein the carbon/silicon-containing precursor comprises octamethylcyclotetrasiloxane (OMCTS), tetramethylcyclotetrasiloxane (TMCTS), tetramethoxysilane (TMOS) or combinations thereof.

11. The method of claim 9, wherein the remote plasma is a microwave plasma.

12. The method of claim 9, wherein the oxygen containing precursor comprises oxygen (O₂).

13. The method of claim 9, further comprising delivering the deposition precursor, activating the oxygen containing precursor, delivering the activated oxygen-containing precursor to the deposition precursor to deposit the carbon/silicon-containing low k material and curing the carbon/silicon-containing low k material one or more times to achieve a desired thickness.

14. The method of claim 9, wherein the temperature of the processing chamber is brought to a temperature between 50 degrees Celsius and 100 degrees Celsius prior to delivering the deposition precursor.

15. The method of claim 9, wherein the carbon oxide gas comprises carbon dioxide, carbon monoxide or combinations thereof.

16. The method of claim 9, wherein the carbon/silicon-containing low k material is cured by a UV radiation cure.

17. The method of claim 9, wherein the substrate is heated to a temperature between 200 degrees Celsius and 550 degrees Celsius prior to curing the carbon/silicon-containing low k material.

18. A method of forming a low k film, comprising:
positioning a substrate in a processing region of a processing chamber;
delivering a deposition precursor to the processing region, the deposition precursor comprising octamethylcyclotetrasiloxane (OMCTS) and tetramethoxysilane (TMOS);
forming a remote plasma in the presence of oxygen (O₂) to create an activated oxygen;
delivering the activated oxygen to the deposition precursor in the presence of the substrate to deposit a carbon/silicon-containing low k film on the substrate;
delivering a curing gas comprising carbon dioxide or carbon monoxide to the processing chamber;
controlling the temperature of the substrate such that the substrate is between 200 degrees Celsius and 550 degrees Celsius; and
delivering UV radiation to the substrate and the curing gas to create a cured carbon/silicon-containing low k film.

19. The method of claim 18, wherein the temperature of the processing chamber is brought to a temperature between 50 degrees Celsius and 100 degrees Celsius prior to delivering the deposition precursor.

20. The method of claim 18, wherein the UV radiation is delivered to the substrate at a power level between 30% and 90% of the maximum power.
